(19) United States
(12) Patent Application Publication
(10) Pub. No.: US 2024/0417925 A1
(43) Pub. Date: Dec. 19, 2024

(54) COLOR CONTROL METHOD, COLOR CONTROL DEVICE AND COLOR CONTROL SYSTEM

(71) Applicant: Newtech Textile Technology Development (Shanghai) Co., LTD, Shanghai (CN)

(72) Inventors: Po-Wen CHUNG, Shanghai (CN); Long TIAN, Shanghai (CN); Xin-Gang LIU, Shanghai (CN)

(21) Appl. No.: 18/818,956

(22) Filed: Aug. 29, 2024

Related U.S. Application Data
(63) Continuation of application No. PCT/CN2023/123652, filed on Oct. 10, 2023.

(30) Foreign Application Priority Data
Feb. 16, 2023 (CN) 202310126066.4

(51) Int. Cl. D06P 1/00

(52) U.S. Cl. CPC D06P 1/0032; D06P 1/0008

(57) ABSTRACT

A color control method for four-color field jet dyeing is provided. The method includes: obtaining fabric parameters of a fabric to be dyed; obtaining a fabric sample color; ascertaining whether predetermined pre-color-development color parameters corresponding to the fabric parameters and the fabric sample color exist in a field jet dyeing database; if not, generating temporary pre-color-development color parameters based on the fabric parameters and the fabric sample color, taking the temporary pre-color-development color parameters as contrast sample parameters, and generating field jet dyeing parameters according to the contrast sample parameters to dye the fabric; and if yes, taking the predetermined pre-color-development color parameters in the field jet dyeing database as contrast sample parameters, and generating field jet dyeing parameters according to the contrast sample parameters to dye the fabric. A color control device and a color control system are further provided.

### REFERENCE TO RELATED APPLICATION

The present application is a continuation of international application No. PCT/CN2023/123652, filed on Oct. 10, 2023, which claims the priority of CN application No. 202310126066.4, filed on Feb. 16, 2023, the entirety of which are incorporated herein by reference.

### BACKGROUND

### Technical Field

The present disclosure relates to a color control method for four-color field jet dyeing, a color control device for four-color field jet dyeing, and a color control system for four-color field jet dyeing.

### Related Art

Textile dyeing is a technology that uses dyes to dye and process a material to be dyed. Traditional textile dyeing, in addition to special dyeing technologies such as discharge dyeing and wax dyeing, is mostly based on the color of the dye to prepare spot color ink for dyeing. In practical use of this technology, the use of spot color dyeing requires comprehensive cleaning of an ink supply system in equipment for each product order, which is time-consuming, laborious and not environment-friendly. Therefore, a four-color field jet dyeing system similar to that used in the printing industry can be used, where the four-color field jet dyeing system combines four-color and field jet dyeing technologies. However, at present, there is an urgent need to develop a color control method for four-color field jet dyeing, as well as a corresponding color control device and color control system.

### SUMMARY

The present disclosure aims to provide a color control method for four-color field jet dyeing, a color control device for four-color field jet dyeing, and a color control system for four-color field jet dyeing. The color control of four-color field jet dyeing can be achieved by virtue of the method, the color control device and the color control system.

A first aspect of the present disclosure relates to a color control method for four-color field jet dyeing. The method includes: obtaining fabric parameters of a fabric to be dyed; obtaining a fabric sample color; ascertaining whether predetermined pre-color-development color parameters corresponding to the fabric parameters and the fabric sample color exist in a field jet dyeing database; if not, generating temporary pre-color-development color parameters based on the fabric parameters and the fabric sample color, taking the temporary pre-color-development color parameters as contrast sample parameters, and generating field jet dyeing parameters according to the contrast sample parameters to dye the fabric; and if yes, taking the predetermined pre-color-development color parameters in the field jet dyeing database as the contrast sample parameters, and generating the field jet dyeing parameters according to the contrast sample parameters to dye the fabric. Therefore, for two cases that the predetermined pre-color-development color parameters corresponding to the fabric parameters and the fabric sample color exist and do not exist in the field jet dyeing database, the present disclosure proposes corresponding solutions to meet the requirements of different cases. In the present disclosure, the four-color includes three primary colors and black, where the three primary colors refer to cyan, magenta and yellow respectively, and the three primary colors and the black are together referred to as CMYK.

In some embodiments, after the fabric parameters of the fabric to be dyed are obtained, whether the fabric parameters corresponding to the fabric to be dyed already exist in the field jet dyeing database can be ascertained; and if not, establishing the fabric parameters corresponding to the fabric to be dyed in the field jet dyeing database.

In some embodiments, when the fabric is dyed through the field jet dyeing parameters, a first four-color field jet dyeing device can be enabled to dye the fabric according to the field jet dyeing parameters, a first fabric color is detected after color fixing, and the first fabric color is compared with the contrast sample parameters to obtain a first fabric color deviation, where if the first fabric color deviation is less than or equal to a color deviation threshold, a color development process is performed directly; and if the first fabric color deviation is greater than the color deviation threshold, the field jet dyeing parameters are readjusted, and the first four-color field jet dyeing device and/or a second four-color field jet dyeing device arranged at a downstream side of the first four-color field jet dyeing device is enabled to perform online adjustment of dyeing according to the adjusted field jet dyeing parameters until the first fabric color deviation is less than or equal to the color deviation threshold. Therefore, the advantages of four-color field jet dyeing can be fully used, that is, a four-color nozzle can be directly used for field jet dyeing without changing an ink system, and controlled online adjustment of dyeing can be achieved by online real-time monitoring of the fabric color and real-time adjustment of the dyeing parameters according to the color deviation.

In some embodiments, the adjusted field jet dyeing parameters for the first four-color field jet dyeing device and/or the second four-color field jet dyeing device can be provided according to the first fabric color deviation and a current dye concentration.

In some embodiments, if it is ascertained that the predetermined pre-color-development color parameters corresponding to the fabric parameters and the fabric sample color do not exist in the field jet dyeing database, after color development of the fabric, a second fabric color after color development can be detected, and the second fabric color is compared with the fabric sample color to obtain a second fabric color deviation, where if the second fabric color deviation is less than or equal to the color deviation threshold, batch production is performed based on the field jet dyeing parameters used in a dyeing process before the color development process; and if the second fabric color deviation is greater than the color deviation threshold, the contrast sample parameters and the field jet dyeing parameters are readjusted, and the dyeing and color development are performed again until the second fabric color deviation is less than or equal to the color deviation threshold. Therefore, for the case that the predetermined pre-color-development color parameters corresponding to the fabric parameters and the fabric sample color do not exist in the field jet dyeing database, the present disclosure proposes corresponding solutions for different cases after color development, and especially for the case that the color deviation requirement is met during dyeing but there is an unacceptable color deviation after color development.

In some embodiments, the adjusted contrast sample parameters and field jet dyeing parameters can be provided according to the second fabric color deviation.

In some embodiments, the temporary pre-color-development color parameters can be computed and simulated by a field jet dyeing database model.

In some embodiments, the fabric sample color can be detected by a first color detection device to obtain the fabric sample color.

In some embodiments, the first fabric color can be detected by a second color detection device.

In some embodiments, the second fabric color can be detected by the first color detection device.

In some embodiments, if it is ascertained that the fabric parameters corresponding to the fabric to be dyed do not exist in the field jet dyeing database, monogenetic dyes with different concentrations in three three-primary color dyes and one black dye can be used for performing field jet dyeing on the fabric and performing color development on a textile, where color parameters before color development of the fabric are detected by the second color detection device, color parameters after color development of the fabric are detected by the first color detection device, and a new field jet dyeing database for the fabric is generated by the field jet dyeing database model based on the color parameters before color development of the fabric and the color parameters after color development of the fabric. Therefore, for the case that the fabric parameters corresponding to the fabric to be dyed do not exist in the field jet dyeing database, the present disclosure proposes a corresponding solution. Here, the three-primary color dyes include a cyan dye, a magenta dye and a yellow dye.

In some embodiments, the field jet dyeing parameters can be generated according to the contrast sample parameters and inputted running speed.

A second aspect of the present disclosure relates to a color control device for four-color field jet dyeing. The color control device is configured to implement the color control method in the present disclosure.

A third aspect of the present disclosure further relates to a color control system for four-color field jet dyeing. The color control system includes: at least one four-color field jet dyeing device, configured to use three three-primary color dyes and one black dye to perform four-color field jet dyeing according to field jet dyeing parameters; a first color detection device, configured to detect a fabric sample color and/or a fabric color after color development; a second color detection device, arranged at a downstream side of the corresponding four-color field jet dyeing device in a movement direction of a fabric and configured to detect the fabric color after dyeing and before color development; a storage device, storing a field jet dyeing database; and a color control device, in communication connection with the four-color field jet dyeing device, the first color detection device, the second color detection device and the storage device.

In some embodiments, the field jet dyeing parameters may include at least one of the following parameters: a concentration of a dye ejected by each four-color field jet dyeing device, a spraying quantity of the dye ejected by each four-color field jet dyeing device, a spraying work distance of each four-color field jet dyeing device, a gas field parameter of each four-color field jet dyeing device, and an electric field parameter of each four-color field jet dyeing device.

In some embodiments, the four-color field jet dyeing device can be configured to eject four-color dyes by virtue of field jet, and these dyes are mixed on a surface layer of the fabric to present a predetermined final color on the fabric.

In some embodiments, the first color detection device and/or the second color detection device can be constructed to be separated and includes a color detection camera and a spectrometer.

In some embodiments, the first color detection device and/or the second color detection device can be constructed to be integrated and can be constructed as an integrated color detection camera integrated with a color sensor.

In some embodiments, the color detection camera may include a light source, an integrating sphere, a light trap, a lens and an optical fiber head. The optical fiber head and the spectrometer are connected by an optical fiber; the light trap is arranged at a mirror reflection hole of the integrating sphere; the optical fiber head is arranged to receive light emitted by a receiver hole of the integrating sphere; and the lens is arranged between the receiver hole of the integrating sphere and the optical fiber head.

In some embodiments, the integrated color detection camera may further include a light source, an integrating sphere, a light trap and a lens. The light trap is arranged at a mirror reflection hole of the integrating sphere; the color sensor is arranged to receive light emitted by a receiver hole of the integrating sphere; and the lens is arranged between the receiver hole of the integrating sphere and the color sensor.

In some embodiments, the light source can be constructed as a coaxial light source with an LED array.

In some embodiments, the light source can be selected from the group comprising an A standard light source, a C standard light source, D-series standard light sources D50, D65 and D75, and an F standard light source that comply with CIE regulations.

In some embodiments, the color temperature of the A standard light source can be 2500 K to 3000 K, the color temperature of the C standard light source can be 6500 K to 7000 K, the color temperature of the D-series standard light sources can be 4500 K to 8000 K, and the color temperature of the F standard light source can be 2500 K to 3000 K.

In some embodiments, a plurality of photodiodes can be integrated on a single chip of the color sensor, where a first photodiode in the plurality of photodiodes is provided with a red light filter, a second photodiode in the plurality of photodiodes is provided with a green light filter, a third photodiode in the plurality of photodiodes is provided with a blue light filter, and the remaining photodiodes are not provided with light filters.

In some embodiments, the integrating sphere can be constructed as a d/8 degree integrating sphere.

In some embodiments, a heating device can be arranged at the downstream side of the four-color field jet dyeing device along the movement direction of the fabric, the heating device is configured to heat the dyed fabric to fix the color of the fabric, and the second color detection device is arranged at a downstream side of the heating device, where the four-color field jet dyeing device, the heating device and the second color detection device together constitute a four-color dyeing and color detection assembly.

In some embodiments, the four-color dyeing and color detection assemblies can be arranged in pairs on two sides of the fabric.

In some embodiments, the first color detection device can be arranged above a fabric sample table.

In some embodiments, color light can be received by the optical fiber head, and the received color light is transmitted to the spectrometer by the optical fiber, where an output end of the spectrometer is in communication connection with an input end of the color control device.

In some embodiments, the color light can be received by the color sensor, the received color light is corrected by a spectral response curve to compute a color difference result, and the color difference result is transmitted to the color control device by the communication connection between an output end of the color sensor and the input end of the color control device.

The present disclosure has the beneficial effect that a color control method for four-color field jet dyeing, as well as a corresponding color control device and color control system are developed for the four-color field jet dyeing achieved based on a four-color system in combination with a field jet textile dyeing system, thus achieving the intelligent control of the four-color field jet dyeing. The primary development task of the current printing and dyeing industry is to form a digital monitoring system covering the entire printing and dyeing process equipment, and establish a digital printing and dyeing workshop. The present disclosure combines online monitoring and control to form a digital monitoring system covering the entire printing and dyeing process equipment. The digital monitoring system performs comprehensive monitoring of mechanical parameters, process parameters and process quality to form closed-loop control for four-color field jet dyeing.

The technical features mentioned above, the technical features to be mentioned below, and the technical features shown in the accompanying drawings can be combined with each other arbitrarily, as long as the combined technical features are not contradictory to each other. All technically feasible feature combinations are included in the technical content recited in the specification.

### BRIEF DESCRIPTION OF THE DRAWINGS

The present disclosure is further described below with reference to the schematic accompanying drawings by exemplary implementations, where

FIG. 1 is a schematic diagram of a color control system according to an embodiment of the present disclosure.

FIG. 2a is a schematic diagram of an integrated first color detection device and/or second color detection device in a color control system according to an embodiment of the present disclosure.

FIG. 2b is a schematic diagram of a separate first color detection device and/or second color detection device in a color control system according to an embodiment of the present disclosure.

FIG. 3 is a flowchart of a color control method for four-color field jet dyeing according to an embodiment of the present disclosure.

### DETAILED DESCRIPTION

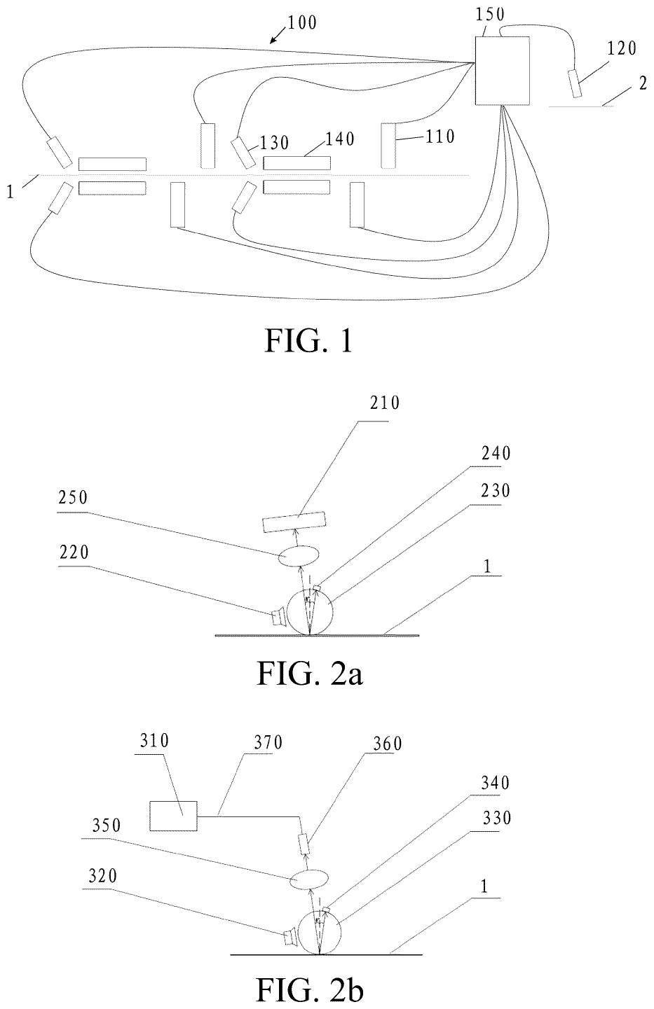

FIG. 1 is a schematic diagram of a color control system 100 according to an embodiment of the present disclosure.

In the embodiment shown in FIG. 1, the color control system 100 includes a first color detection device 120, and the first color detection device 120 can be configured to detect a fabric sample color. In addition, the first color detection device 120 can also be configured to detect a fabric color after color development. In order to better detect the color of a fabric sample 2, the first color detection device 120 can be arranged above a fabric sample table. Whether predetermined pre-color-development color parameters corresponding to fabric parameters and fabric sample color exist in a field jet dyeing database can be determined according to the obtained fabric sample color and fabric parameters of a fabric 1 to be dyed, so as to generate temporary pre-color-development color parameters or obtain the predetermined pre-color-development color parameters, thereby determining corresponding contrast sample parameters to serve as a basis for determining the color deviation degree during dyeing.

The color control system 100 further includes four four-color field jet dyeing devices 110, and the four-color field jet dyeing devices 110 are configured to use three three-primary color dyes and one black dye to perform four-color field jet dyeing. The four four-color field jet dyeing devices 110 can be respectively arranged on two sides of the fabric, so that double-sided dyeing of the fabric 1 can be achieved, or single-sided dyeing can be achieved by only using two of the single-sided four-color field jet dyeing devices 110. In some embodiments, the four-color field jet dyeing devices 110 can also be only arranged on one side of the fabric 1, thus achieving single-sided dyeing. The four-color field jet dyeing devices 110 are configured to use three three-primary color dyes and one black dye to perform four-color field jet dyeing. In this embodiment, each four-color field jet dyeing device 110 is respectively constructed as a four-color nozzle for four-color field jet dyeing.

In this embodiment, the four-color nozzle has four dyeing nozzles, and the four dyeing nozzles are respectively configured to eject dyes with one of three primary colors and black by virtue of field jet. Of course, the present disclosure is not limited to this. Any other number of dyeing nozzles can be arranged. Similarly, any other number of four-color field jet dyeing devices 110 can also be arranged. For example, only one or more than two four-color field jet dyeing devices 110 can be arranged on the same side. When two or more four-color field jet dyeing devices 110 are arranged on the same side, the four-color field jet dyeing device 110 arranged at a downstream side can achieve color complement, where the color complement can be achieved by four-color field jet dyeing parameters adjusted based on online color detection, thus achieving online adjustment of dyeing. Of course, in a case that only one four-color field jet dyeing device 110 is arranged on the same side, online adjustment of dyeing can also be achieved, where the four-color field jet dyeing device 110 can adjust its own four-color field jet dyeing parameters in real time according to the downstream online color detection, that is, the advantages of four-color dyeing are fully used, and a color deviation from the contrast sample parameters is reduced by the change of its own four-color field jet dyeing parameters.

As shown in FIG. 1, the color control system 100 further includes a heating device 140 arranged at the downstream side of the four-color field jet dyeing device 110 along a movement direction of the fabric 1. The heating device 140 is configured to heat the dyed fabric to fix the color of the fabric. In this embodiment, the heating device 140 is constructed as an oven. The oven can heat dyes by thermal radiation, thus achieving color fixing. In other embodiments, the heating device 140 can also be constructed as a hot air type heater which can use hot air heating for dyeing, thus achieving color fixing.

In order to detect the color of the dyed fabric, the color control system 100 includes a second color detection device 130 arranged at the downstream side of the corresponding four-color field jet dyeing device 110 in the movement direction of the fabric 1. In the embodiment, the second color detection device 130 is also arranged at a downstream side of the heating device 140, so as to detect a first fabric color after color fixing. The first fabric color is a fabric color after dyeing and before color development. After color development of the fabric, a second fabric color is formed on the fabric. The second fabric color can be detected by the first color detection device 120. In some embodiments, the second fabric color can be detected by another color detection device different from the first color detection device 120 and the second color detection device 130.

In order to perform color control of four-color field jet dyeing, the color control system 100 further includes a color control device 150 for color control and a storage device matched with the color control device 150. A field jet dyeing database can be stored in the storage device. The color control device 150 can be in communication connection with the four-color field jet dyeing device 110 to control the four-color field jet dyeing device 110. The color control device 150 can also be in communication connection with the first color detection device 120 and the second color detection device 130 to receive detection data from the first color detection device 120 and the second color detection device 130. The color control device 150 can also be in communication connection with the storage device to call data from the storage device or store data in the storage device. By connecting the color control device 150 with the four-color field jet dyeing device 110, the first color detection device 120 and the second color detection device 130, online control or online adjustment of dyeing of the four-color field jet dyeing device 110 can be achieved. Therefore, the first fabric color detected by the second color detection device 130 can be inputted to the color control device 150, and then, the color control device 150 can compare the first fabric color with the contrast sample parameters generated based on the fabric sample color obtained by the first color detection device 120 to obtain a first fabric color deviation, where if the first fabric color deviation is less than or equal to a color deviation threshold, a color development process is performed directly; and if the first fabric color deviation is greater than the color deviation threshold, the field jet dyeing parameters are readjusted, and the corresponding four-color field jet dyeing device 110 is enabled to perform online adjustment of dyeing according to the adjusted field jet dyeing parameters until the first fabric color deviation is less than or equal to the color deviation threshold. In addition, for the case that the predetermined pre-color-development color parameters corresponding to the fabric parameters and the fabric sample color do not exist in the field jet dyeing database, after color development of the fabric, the second fabric color after color development, detected by the first color detection device 120, can be inputted to the color control device 150, and then, the color control device 150 can compare the second fabric color with the fabric sample color to obtain a second fabric color deviation, where if the second fabric color deviation is less than or equal to the color deviation threshold, batch production is performed based on the field jet dyeing parameters used in a dyeing process before the color development process; and if the second fabric color deviation is greater than the color deviation threshold, the contrast sample parameters and the field jet dyeing parameters are readjusted, and the dyeing and color development are performed again until the second fabric color deviation is less than or equal to the color deviation threshold.

The color control device 150 and the storage device can be integrally constructed. In some embodiments, the color control device 150 and the storage device can be integrated. In some embodiments, the color control device 150 and the storage device can also be separated.

As shown in FIG. 1, on a dyeing production line of the fabric 1, the four-color field jet dyeing device 110, the heating device 140 and the second color detection device 130 can together constitute a four-color dyeing and color detection assembly. In this embodiment, four groups of four-color dyeing and color detection assemblies are arranged. The four groups of four-color dyeing and color detection assemblies are arranged in pairs on two sides of the fabric 1. In some embodiments, two groups, six groups or eight groups of four-color dyeing and color detection assemblies can also be arranged. For the sake of simplicity, in FIG. 1, corresponding devices in only one of the four-color dyeing and color detection assemblies are marked with reference numerals.

The construction of the first color detection device 120 and/or the second color detection device 130 according to an embodiment of the present disclosure is described in detail below with reference to FIG. 2a and FIG. 2b.

As shown in FIG. 2a, the first color detection device 120 and/or the second color detection device 130 is constructed to be integrated and is constructed as an integrated color detection camera integrated with a color sensor 210. The integrated color detection camera further includes a light source 220, an integrating sphere 230, a light trap 240 and a lens 250. The light trap 240 is arranged at a mirror reflection hole of the integrating sphere 230; the color sensor 210 is arranged to receive light emitted by a receiver hole of the integrating sphere 230; and the lens 250 is arranged between the receiver hole of the integrating sphere 230 and the color sensor 210. Color light can be received by the color sensor 210, the received color light can be corrected by a spectral response curve to compute a color difference result, and the color difference result is transmitted to the color control device 150 by the communication connection between an output end of the color sensor 210 and an input end of the color control device 150. A plurality of, preferably 16 photodiodes can be integrated on a single chip of the color sensor 210, where preferably 4 first photodiodes in the plurality of photodiodes are provided with red light filters, preferably 4 second photodiodes in the plurality of photodiodes are provided with green light filters, preferably 4 third photodiodes in the plurality of photodiodes are provided with blue light filters, and the remaining photodiodes are not provided with light filters.

As shown in FIG. 2b, the first color detection device 120 and/or the second color detection device 130 is constructed to be separated and includes a color detection camera and a spectrometer 310. The color detection camera includes a light source 320, an integrating sphere 330, a light trap 340, a lens 350 and an optical fiber head 360. The optical fiber head 360 and the spectrometer 310 are connected by an optical fiber 370; the light trap 340 is arranged at a mirror reflection hole of the integrating sphere 330; the optical fiber head 360 is arranged to receive light emitted by a receiver hole of the integrating sphere 330; and the lens 350 is arranged between the receiver hole of the integrating sphere 330 and the optical fiber head 360. The color light can be received by the optical fiber head 360, and the received color light can be transmitted to the spectrometer 310 by the optical fiber 370, where an output end of the spectrometer 310 is in communication connection with the input end of the color control device 150.

In the first color detection device 120 and/or the second color detection device 130 with two different constructions, the light sources 220 and 320 can be constructed as a coaxial light source with an LED array. The light sources 220 and 320 can be selected from the group comprising an A standard light source, a C standard light source, D-series standard light sources D50, D65 and D75, and an F standard light source that comply with CIE regulations. The color temperature of the A standard light source is 2500 K to 3000 K, preferably 2856 K; the color temperature of the C standard light source is 6500 K to 7000 K, preferably 6774 K; the color temperature of the D-series standard light sources is 4500 K to 8000 K, preferably 5000 K to 7500 K; and the color temperature of the F standard light source is 2500 K to 3000 K, preferably 2700 K. In addition, the integrating spheres 230 and 330 can be constructed as d/8 degree integrating spheres. A side wall of each of the integrating spheres 230 and 330 is provided with an entrance port, and light emitted by the light source enters the integrating spheres 230 and 330 through the corresponding entrance port. The fabric 1 is located at lower openings of the integrating spheres 230 and 330. The color sensor 210 and the optical fiber head 360 are arranged at a −8° position perpendicular to a normal of the fabric 1 on the corresponding integrating spheres 230 and 330. The light traps 240 and 340 can be arranged at a +8° position perpendicular to the normal of the fabric 1 on the corresponding integrating spheres 230 and 330.

The field jet dyeing parameter includes at least one of the following parameters: a concentration of a dye ejected by each four-color field jet dyeing device 110, a spraying quantity of the dye ejected by each four-color field jet dyeing device 110, a spraying work distance of each four-color field jet dyeing device 110, a gas field parameter of each four-color field jet dyeing device 110, and an electric field parameter of each four-color field jet dyeing device 110.

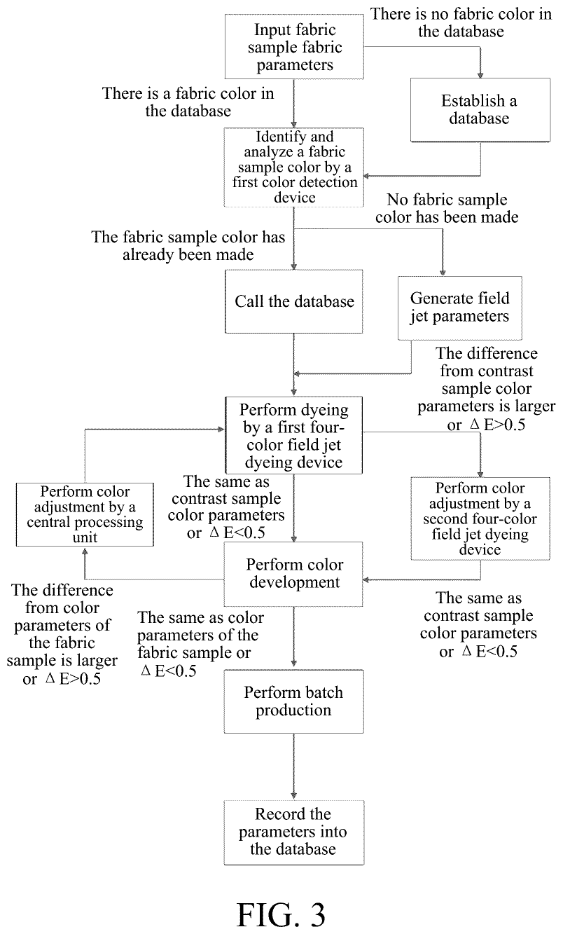

A color control method for four-color field jet dyeing according to an embodiment of the present disclosure is described below with reference to FIG. 3.

In the method, first, fabric parameters of the fabric 1 to be dyed are obtained, for example, the fabric parameters are inputted to the color control system 100. After the fabric parameters of the fabric 1 to be dyed are obtained, whether the fabric parameters corresponding to the fabric 1 to be dyed already exist in the field jet dyeing database can be ascertained; if yes, the next step is performed directly; and if not, the fabric parameters corresponding to the fabric 1 to be dyed are established in the field jet dyeing database.

Then, the color of the fabric sample 2 is obtained, for example, the fabric sample color is obtained by the first color detection device 120. After the fabric sample color is obtained, whether predetermined pre-color-development color parameters corresponding to the fabric parameters and the fabric sample color exist in the field jet dyeing database can be ascertained; if yes, the predetermined pre-color-development color parameters in the field jet dyeing database are taken as contrast sample parameters, and field jet dyeing parameters are generated according to the contrast sample parameters to dye the fabric; and if not, temporary pre-color-development color parameters are generated based on the fabric parameters and the fabric sample color, the temporary pre-color-development color parameters are taken as the contrast sample parameters, and the field jet dyeing parameters are generated according to the contrast sample parameters to dye the fabric. Here, the field jet dyeing parameters are generated according to the contrast sample parameters and inputted running speed. The temporary pre-color-development color parameters are computed and simulated by a field jet dyeing database model.

Then, when the fabric is dyed through the field jet dyeing parameters, a first four-color field jet dyeing device is enabled to dye the fabric according to the field jet dyeing parameters, a first fabric color is detected by the second color detection device 130 after color fixing, and the first fabric color is compared with the contrast sample parameters to obtain a first fabric color deviation, where if the first fabric color deviation is less than or equal to a color deviation threshold, a color development process is performed directly; and if the first fabric color deviation is greater than the color deviation threshold, the field jet dyeing parameters are readjusted, and the first four-color field jet dyeing device and/or a second four-color field jet dyeing device arranged at a downstream side of the first four-color field jet dyeing device is enabled to perform online adjustment of dyeing according to the adjusted field jet dyeing parameters until the first fabric color deviation is less than or equal to the color deviation threshold. As mentioned above, the online adjustment of dyeing can be completed together by the first four-color field jet dyeing device and the second four-color field jet dyeing device, that is, the second four-color field jet dyeing device is used for color complement; and the online adjustment of dyeing can also be completed by the first four-color field jet dyeing device, that is, the field jet dyeing parameters of the first four-color field jet dyeing device are adjusted in real time according to the downstream color deviation detection result. Here, the adjusted field jet dyeing parameters for the first four-color field jet dyeing device and/or the second four-color field jet dyeing device are provided according to the first fabric color deviation and a current dye concentration.

If it is ascertained that the predetermined pre-color-development color parameters corresponding to the fabric parameters and the fabric sample color do not exist in the field jet dyeing database, after color development of the fabric, a second fabric color after color development is detected by the first color detection device 120, and the second fabric color is compared with the fabric sample color to obtain a second fabric color deviation, where if the second fabric color deviation is less than or equal to the color deviation threshold, batch production (also known as “bulk production”) is performed based on the field jet dyeing parameters used in a dyeing process before the color development process; and if the second fabric color deviation is greater than the color deviation threshold, the contrast sample parameters and the field jet dyeing parameters are readjusted, and the dyeing and color development are performed again until the second fabric color deviation is less than or equal to the color deviation threshold. Here, the adjusted contrast sample parameters and field jet dyeing parameters are provided according to the second fabric color deviation. In addition, if it is ascertained that the predetermined pre-color-development color parameters corresponding to the fabric parameters and the fabric sample color exist in the field jet dyeing database, after the dyeing meeting requirements and the subsequent color development are completed, it is not necessary to detect the second fabric color after color development, and the batch production is performed directly.

If it is ascertained that the fabric parameters corresponding to the fabric 1 to be dyed do not exist in the field jet dyeing database, monogenetic dyes with different concentrations in three three-primary color dyes and one black dye are used for performing field jet dyeing on the fabric and performing color development on a textile, where color parameters before color development of the fabric are detected by the second color detection device 130, color parameters after color development of the fabric are detected by the first color detection device 120, and a new field jet dyeing database for the fabric 1 is generated by the field jet dyeing database model based on the color parameters before color development of the fabric and the color parameters after color development of the fabric.

In the present disclosure, the color deviation threshold ΔE may be 0.5. Of course, other values may also be considered.

The present disclosure is further described below with non-restrictive embodiments. However, it should be noted that these embodiments should not be considered as limitations to the present disclosure.

Because the specifications of the fabric 1 (including yarn specifications, density, fabric texture and the like of the fabric 1) may affect the final color presentation during dyeing, in a specific implementation process, a corresponding field jet dyeing database is established based on the fabric 1. Therefore, the sample processing mainly involves two cases: (1) a field jet dyeing database with the fabric 1, and (2) a field jet dyeing database without the fabric 1.

The case with a field jet dyeing database may also be divided into: (1-1) a fabric sample color has been made, and (1-2) no fabric sample color has been made.

### Embodiment 1

For the case that a color control system 100 for four-color field jet dyeing has already made a fabric sample color for this machine and a field jet dyeing database has already stored parameters of a fabric 1, a first color control process includes:
1) Fabric parameters are inputted to the color control system 100, a color of a fabric sample 2 is identified by a first color detection device 120, then the field jet dyeing database can be called, and pre-color-development color parameters corresponding to the fabric of the fabric sample 2 are taken as contrast sample parameters. In combination with the running speed inputted to the color control system 100, the color control system 100 can provide accurate field jet dyeing parameters (such as concentration, spraying quantity, spraying work distance, gas field parameters and electric field parameters of four-color dye liquor).
2) The fabric 1 enters a dyeing production line, and then, the fabric is dyed by a first four-color field jet dyeing device according to the field jet dyeing parameters provided by the system; after drying, the color is identified and analyzed by a second color detection device 130 matched with the first four-color field jet dyeing device, and is compared with a contrast sample in the field jet dyeing database; and if the parameters are the same or when ΔE<0.5, a color development process can be performed directly. If the difference between the color identified and analyzed by the second color detection device 130 and the parameters of the contrast sample in the field jet dyeing database is too large or when ΔE>0.5, it is fed back to a color control device 150; the color control device 150 automatically provides field jet dyeing adjustment parameters of a second four-color field jet dyeing device arranged at a downstream side of the first four-color field jet dyeing device according to the color deviation and the current dye liquor concentration to perform online adjustment of dyeing; after drying, the color is identified and analyzed by the second color detection device 130 matched with the second four-color field jet dyeing device, and is compared with the contrast sample in the field jet dyeing database; and if the parameters are the same or when ΔE<0.5, a color development process can be performed directly.

### Embodiment 2

For the case that a color control system 100 for four-color field jet dyeing does not make a fabric sample color for this machine and a field jet dyeing database has already stored parameters of the fabric 1, a second color control process includes:
1) Fabric parameters are inputted to the color control system 100, a fabric sample color is identified by a first color detection device 120, then the field jet dyeing database can be called, and pre-color-development color parameters corresponding to the fabric of a fabric sample 2 can be computed and simulated by a field jet dyeing database model and are taken as contrast sample parameters. In combination with the running speed inputted to the color control system 100, the color control system 100 can generate recommended field jet dyeing parameters (such as concentration, spraying quantity, spraying work distance, gas field parameters and electric field parameters of four-color dye liquor).
2) The fabric 1 enters a dyeing production line, and then, the fabric is dyed by a first four-color field jet dyeing device according to the recommended field jet dyeing parameters; after drying, the color is identified and analyzed by a second color detection device 130 matched with the first four-color field jet dyeing device, and is compared with a contrast sample in the field jet dyeing database; and if the parameters are the same or when ΔE<0.5, a color development process can be performed directly. If the difference between the color identified and analyzed by the second color detection device 130 and the parameters of the contrast sample in the field jet dyeing database is too large or when ΔE>0.5, it is fed back to a color control device 150; the color control device 150 automatically provides field jet dyeing adjustment parameters of a second four-color field jet dyeing device arranged at a downstream side of the first four-color field jet dyeing device according to the color deviation and the current dye liquor concentration to perform online adjustment of dyeing; after drying, the color is identified and analyzed by the second color detection device 130 matched with the second four-color field jet dyeing device, and is compared with the contrast sample in the field jet dyeing database; and if the parameters are the same or when ΔE<0.5, a color development process can be performed directly.
3) A fabric color after color development is identified by the first color detection device 120; if fabric color parameters are the same as color parameters of the fabric sample 2 or when ΔE<0.5, batch production can be performed with the parameters according to the first color control process; if the difference between the fabric color parameters and the color parameters of the fabric sample 2 is too large or when ΔE>0.5, it is fed back to the color control device 150; and the color control device 150 provides adjusted pre-color-development contrast sample and recommended field jet dyeing parameters according to the difference between the two colors, and then repeats steps 2) and 3) in the second color control process until the fabric color parameters are the same as the color parameters of the fabric sample 2 or ΔE<0.5. Then, the fabric sample color parameters, the corresponding pre-color-development color parameters and the field jet dyeing parameters are recorded into the field jet dyeing database.

### Embodiment 3

For the case that a color control system 100 for four-color field jet dyeing does not store data of the fabric to be dyed of a fabric sample color in a field jet dyeing database, a third color control process includes:
1) Fabric parameters are inputted to the color control system 100, and if there is no corresponding field jet dyeing database model, a field jet dyeing database needs to be established first.
2) Different concentrations of single colors from cyan, magenta, yellow and black are used for performing field jet dyeing on the fabric, color parameters before color development of a fabric 1 are recorded by a second color detection device 130, and color parameters after color development of the fabric 1 are recorded by a first color detection device 120. Based on this, the field jet dyeing database of the fabric 1 is automatically generated by field jet dyeing database model software.
3) The second color control process is repeated.

It should be noted that the terms used here are for the purpose of explaining specific aspects only, and are not intended to limit the content of the disclosure. The singular forms “a/an” and “the one” used here should include plural forms, unless otherwise explicitly stated in the context. It can be understood that the terms “comprise”, “include” and other similar terms, when used in application documents, specifically explain the existence of the described operations, elements and/or components, without excluding the existence or addition of one or more other operations, elements, components and/or combinations thereof. The term “and/or” used here includes all arbitrary combinations of one or more related listed items. In the description of the accompanying drawings, similar reference numerals always represent similar elements.

The thicknesses of the elements in the accompanying drawings can be exaggerated for clarity. In addition, it can be understood that if an element is referred to as being located on another element, coupled with another element or connected with another element, the one element may be directly formed on the another element, coupled with the another element or connected with the another element, or there may be one or more intermediate elements between them. On the contrary, if the expressions “directly located on . . . ”, “directly coupled with . . . ”, and “directly connected with . . . ” are used here, it means that there is no intermediate element.

Here, the terms such as “top”, “bottom”, “above”, “below”, “on” and “under” are used for describing the relationship between one element, layer or area and another element, layer or area shown in the accompanying drawings. It can be understood that in addition to the orientation described in the accompanying drawings, these terms should also include other orientations of the device.

It can be understood that although the terms such as “first” and “second” can be used for describing different elements here, these elements should not be limited by these terms. These terms are only used for distinguishing one element from another element. Therefore, a first element may be referred to as a second element without departing from the teachings of the concept of the present disclosure. It can also be considered that all exemplary implementations disclosed here can be arbitrarily combined with each other.

Finally, it should be noted that the above embodiments are only used for understanding the present disclosure and do not limit the scope of protection of the present disclosure. Those having ordinary skilled in the art can make modifications based on the above embodiments, and these modifications do not depart from the scope of protection of the present disclosure.

What is claimed is:

1. A color control method for four-color field jet dyeing, comprising:
obtaining fabric parameters of a fabric to be dyed;
obtaining a fabric sample color;
ascertaining whether predetermined pre-color-development color parameters corresponding to the fabric parameters and the fabric sample color exist in a field jet dyeing database;
if not, generating temporary pre-color-development color parameters based on the fabric parameters and the fabric sample color, taking the temporary pre-color-development color parameters as contrast sample parameters, and generating field jet dyeing parameters according to the contrast sample parameters to dye the fabric; and
if yes, taking the predetermined pre-color-development color parameters in the field jet dyeing database as the contrast sample parameters, and generating the field jet dyeing parameters according to the contrast sample parameters to dye the fabric.

2. The method according to claim 1, wherein after the fabric parameters of the fabric to be dyed are obtained, ascertaining whether the fabric parameters corresponding to the fabric to be dyed already exist in the field jet dyeing database; if not, establishing the fabric parameters corresponding to the fabric to be dyed in the field jet dyeing database; and/or
when the fabric is dyed through the field jet dyeing parameters, enabling a first four-color field jet dyeing device to dye the fabric according to the field jet dyeing parameters, detecting a first fabric color after color fixing, and comparing the first fabric color with the contrast sample parameters to obtain a first fabric color deviation, wherein
if the first fabric color deviation is less than or equal to a color deviation threshold, directly performing a color development process; and
if the first fabric color deviation is greater than the color deviation threshold, readjusting the field jet dyeing parameters, and enabling the first four-color field jet dyeing device and/or a second four-color field jet dyeing device arranged at a downstream side of the first four-color field jet dyeing device to perform online adjustment of dyeing according to the adjusted field jet dyeing parameters until the first fabric color deviation is less than or equal to the color deviation threshold.

3. The method according to claim 2, wherein the adjusted field jet dyeing parameters for the first four-color field jet dyeing device and/or the second four-color field jet dyeing device are provided according to the first fabric color deviation and a current dye concentration; and/or
if it is ascertained that the predetermined pre-color-development color parameters corresponding to the fabric parameters and the fabric sample color do not exist in the field jet dyeing database, after color development of the fabric, detecting a second fabric color after color development, and comparing the second fabric color with the fabric sample color to obtain a second fabric color deviation, wherein
if the second fabric color deviation is less than or equal to the color deviation threshold, performing batch production based on the field jet dyeing parameters used in a dyeing process before the color development process; and
if the second fabric color deviation is greater than the color deviation threshold, readjusting the contrast sample parameters and the field jet dyeing parameters, and performing the dyeing and color development again until the second fabric color deviation is less than or equal to the color deviation threshold.

4. The method according to claim 3, wherein the adjusted contrast sample parameters and field jet dyeing parameters are provided according to the second fabric color deviation; and/or
the temporary pre-color-development color parameters are computed and simulated by a field jet dyeing database model; and/or
the fabric sample color is detected by a first color detection device to obtain the fabric sample color; and/or
the first fabric color is detected by a second color detection device; and/or
the second fabric color is detected by the first color detection device; and/or
if it is ascertained that the fabric parameters corresponding to the fabric to be dyed do not exist in the field jet dyeing database, using monogenetic dyes with different concentrations in three three-primary color dyes and one black dye for performing field jet dyeing on the fabric and performing color development on a textile, wherein color parameters before color development of the fabric are detected by the second color detection device, color parameters after color development of the fabric are detected by the first color detection device, and a new field jet dyeing database for the fabric is generated by the field jet dyeing database model based on the color parameters before color development of the fabric and the color parameters after color development of the fabric; and/or
generating the field jet dyeing parameters according to the contrast sample parameters and inputted running speed.

5. A color control device for four-color field jet dyeing, configured to implement the method according to claim 4.

6. A color control device for four-color field jet dyeing, configured to implement the method according to claim 3.

7. The method according to claim 2, wherein the adjusted contrast sample parameters and field jet dyeing parameters are provided according to the second fabric color deviation; and/or
the temporary pre-color-development color parameters are computed and simulated by a field jet dyeing database model; and/or
the fabric sample color is detected by a first color detection device to obtain the fabric sample color; and/or
the first fabric color is detected by a second color detection device; and/or
the second fabric color is detected by the first color detection device; and/or
if it is ascertained that the fabric parameters corresponding to the fabric to be dyed do not exist in the field jet dyeing database, using monogenetic dyes with different concentrations in three three-primary color dyes and one black dye for performing field jet dyeing on the fabric and performing color development on a textile, wherein color parameters before color development of the fabric are detected by the second color detection device, color parameters after color development of the fabric are detected by the first color detection device, and a new field jet dyeing database for the fabric is generated by the field jet dyeing database model based on the color parameters before color development of the fabric and the color parameters after color development of the fabric; and/or
generating the field jet dyeing parameters according to the contrast sample parameters and inputted running speed.

8. A color control device for four-color field jet dyeing, configured to implement the method according to claim 7.

9. A color control device for four-color field jet dyeing, configured to implement the method according to claim 2.

10. The method according to claim 1, wherein the adjusted contrast sample parameters and field jet dyeing parameters are provided according to the second fabric color deviation; and/or
the temporary pre-color-development color parameters are computed and simulated by a field jet dyeing database model; and/or
the fabric sample color is detected by a first color detection device to obtain the fabric sample color; and/or
the first fabric color is detected by a second color detection device; and/or
the second fabric color is detected by the first color detection device; and/or
if it is ascertained that the fabric parameters corresponding to the fabric to be dyed do not exist in the field jet dyeing database, using monogenetic dyes with different concentrations in three three-primary color dyes and one black dye for performing field jet dyeing on the fabric and performing color development on a textile, wherein color parameters before color development of the fabric are detected by the second color detection device, color parameters after color development of the fabric are detected by the first color detection device, and a new field jet dyeing database for the fabric is generated by the field jet dyeing database model based on the color parameters before color development of the fabric and the color parameters after color development of the fabric; and/or
generating the field jet dyeing parameters according to the contrast sample parameters and inputted running speed.

11. A color control device for four-color field jet dyeing, configured to implement the method according to claim 10.

12. A color control device for four-color field jet dyeing, configured to implement the method according to claim 1.

13. A color control system for four-color field jet dyeing, comprising:
at least one four-color field jet dyeing device, configured to use three three-primary color dyes and one black dye to perform four-color field jet dyeing according to field jet dyeing parameters;
a first color detection device, configured to detect a fabric sample color and/or a fabric color after color development;
a second color detection device, arranged at a downstream side of the corresponding four-color field jet dyeing device in a movement direction of a fabric and configured to detect the fabric color after dyeing and before color development;
a storage device, storing a field jet dyeing database; and
a color control device, being the color control device according to claim 5 and in communication connection with the four-color field jet dyeing device, the first color detection device, the second color detection device and the storage device.

14. The color control system according to claim 13, wherein the field jet dyeing parameters comprise at least one of the following parameters:
a concentration of a dye ejected by each four-color field jet dyeing device,
a spraying quantity of the dye ejected by each four-color field jet dyeing device,
a spraying work distance of each four-color field jet dyeing device,
a gas field parameter of each four-color field jet dyeing device, and
an electric field parameter of each four-color field jet dyeing device; and/or
the four-color field jet dyeing device is configured to eject four-color dyes by virtue of field jet, and these dyes are mixed on a surface layer of the fabric to present a predetermined final color on the fabric.

15. The color control system according to claim 13, wherein the first color detection device and/or the second color detection device is constructed to be separated and comprises a color detection camera and a spectrometer; and/or
the first color detection device and/or the second color detection device is constructed to be integrated and is constructed as an integrated color detection camera integrated with a color sensor.

16. The color control system according to claim 15, wherein the color detection camera comprises a light source, an integrating sphere, a light trap, a lens and an optical fiber head, the optical fiber head and the spectrometer are connected by an optical fiber, the light trap is arranged at a mirror reflection hole of the integrating sphere, the optical fiber head is arranged to receive light emitted by a receiver hole of the integrating sphere, and the lens is arranged between the receiver hole of the integrating sphere and the optical fiber head; and/or
the integrated color detection camera further comprises a light source, an integrating sphere, a light trap and a lens, the light trap is arranged at a mirror reflection hole of the integrating sphere, the color sensor is arranged to receive light emitted by a receiver hole of the integrating sphere, the lens is arranged between the receiver hole of the integrating sphere and the color sensor, and/or the light source is constructed as a coaxial light source with an LED array; and/or
the light source is selected from the group comprising an A standard light source, a C standard light source, D-series standard light sources D50, D65 and D75, and an F standard light source that comply with CIE regulations; and/or
the color temperature of the A standard light source is 2500 K to 3000 K, the color temperature of the C standard light source is 6500 K to 7000 K, the color temperature of the D-series standard light sources is 4500 K to 8000 K, and the color temperature of the F standard light source is 2500 K to 3000 K; and/or
a plurality of photodiodes are integrated on a single chip of the color sensor, wherein a first photodiode in the plurality of photodiodes is provided with a red light filter, a second photodiode in the plurality of photodiodes is provided with a green light filter, a third photodiode in the plurality of photodiodes is provided with a blue light filter, and the remaining photodiodes are not provided with light filters; and/or
the integrating sphere is constructed as a d/8 degree integrating sphere.

17. The color control system according to claim 15, wherein a heating device is arranged at the downstream side of the four-color field jet dyeing device along the movement direction of the fabric, the heating device is configured to heat the dyed fabric to fix the color of the fabric, and the second color detection device is arranged at a downstream side of the heating device, wherein the four-color field jet dyeing device, the heating device and the second color detection device together constitute a four-color dyeing and color detection assembly; and/or
the four-color dyeing and color detection assemblies are arranged in pairs on two sides of the fabric; and/or
wherein the first color detection device is arranged above a fabric sample table; and/or
color light is received by the optical fiber head, and the received color light is transmitted to the spectrometer by the optical fiber, wherein an output end of the spectrometer is in communication connection with an input end of the color control device; and/or
the color light is received by the color sensor, the received color light is corrected by a spectral response curve to compute a color difference result, and the color difference result is transmitted to the color control device by the communication connection between an output end of the color sensor and the input end of the color control device.

18. The color control system according to claim 14, wherein a heating device is arranged at the downstream side of the four-color field jet dyeing device along the movement direction of the fabric, the heating device is configured to heat the dyed fabric to fix the color of the fabric, and the second color detection device is arranged at a downstream side of the heating device, wherein the four-color field jet dyeing device, the heating device and the second color detection device together constitute a four-color dyeing and color detection assembly; and/or
the four-color dyeing and color detection assemblies are arranged in pairs on two sides of the fabric; and/or
wherein the first color detection device is arranged above a fabric sample table; and/or
color light is received by the optical fiber head, and the received color light is transmitted to the spectrometer by the optical fiber, wherein an output end of the spectrometer is in communication connection with an input end of the color control device; and/or
the color light is received by the color sensor, the received color light is corrected by a spectral response curve to compute a color difference result, and the color difference result is transmitted to the color control device by the communication connection between an output end of the color sensor and the input end of the color control device.

19. The color control system according to claim 13, wherein a heating device is arranged at the downstream side of the four-color field jet dyeing device along the movement direction of the fabric, the heating device is configured to heat the dyed fabric to fix the color of the fabric, and the second color detection device is arranged at a downstream side of the heating device, wherein the four-color field jet dyeing device, the heating device and the second color detection device together constitute a four-color dyeing and color detection assembly; and/or
the four-color dyeing and color detection assemblies are arranged in pairs on two sides of the fabric; and/or
wherein the first color detection device is arranged above a fabric sample table; and/or
color light is received by the optical fiber head, and the received color light is transmitted to the spectrometer by the optical fiber, wherein an output end of the spectrometer is in communication connection with an input end of the color control device; and/or
the color light is received by the color sensor, the received color light is corrected by a spectral response curve to compute a color difference result, and the color difference result is transmitted to the color control device by the communication connection between an output end of the color sensor and the input end of the color control device.
